(19) United States
(12) Patent Application Publication
(10) Pub. No.: US 2026/0088747 A1
(43) Pub. Date: Mar. 26, 2026

(54) MOTOR CONTROL DEVICE

(71) Applicant: TOYOTA JIDOSHA KABUSHIKI KAISHA, Toyota-shi (JP)

(72) Inventor: Kensuke KAMICHI, Nagakute-shi (JP)

(73) Assignee: TOYOTA JIDOSHA KABUSHIKI KAISHA, Toyota-shi (JP)

(21) Appl. No.: 19/214,502

(22) Filed: May 21, 2025

(30) Foreign Application Priority Data
Sep. 24, 2024 (JP) 2024-165507

(51) Int. Cl. H02P 23/30; H02P 23/04

(52) U.S. Cl. CPC H02P 23/30; H02P 23/04

(57) ABSTRACT

A motor control device used in a battery electric vehicle including a motor outputting power to a drive shaft connected to an axle via a gear mechanism, the motor control device controlling the motor such that a torque that is a sum of a required torque and an execution vibration damping torque obtained by multiplying a required vibration damping torque required for suppressing vibration by a gain is output to the drive shaft, and the motor control device being configured to set the gain, when an absolute value of the required torque is equal to or larger than a value of 0 and less than a first value larger than the value of 0, to the value of 0 or a predetermined value larger than the value of 0 and less than a value of 1.

### CROSS-REFERENCE TO RELATED APPLICATION

This application claims priority to Japanese Patent Application No. 2024-165507 filed on Sep. 24, 2024. The disclosure of the above-identified application, including the specification, drawings, and claims, is incorporated by reference herein in its entirety.

### BACKGROUND

### 1. Technical Field

The present disclosure relates to a motor control device.

### 2. Description of Related Art

In the related art, a motor control device of this kind used in a battery electric vehicle has been proposed. The battery electric vehicle includes an engine and a motor (motor generator) connected to a drive shaft connected to an axle via a gear mechanism (for example, see Japanese Unexamined Patent Application Publication No. 2015-104942 (JP 2015-104942 A)). In the device, a sum of a compensation torque for reducing a pulsing component of a torque of the engine and a required torque of the motor is set as a torque command value of the motor. In the device, in a case where the average value of the torque command values is less than an absolute value (amplitude) of the torque command values, the torque command values are corrected such that a value having a positive or negative sign opposite to that of the average value of the torque command values is not commanded to the motor. As a result, a vehicle vibration or an abnormal sound in a case where the torque command value crosses 0 Nm is suppressed.

### SUMMARY

In the above-described motor control device, there is a possibility that the torque command value is uniformly corrected such that the torque command value does not cross 0 Nm even when the absolute value of the torque command value is large. As a result, abnormal sound due to vibration of the sprung structure above the suspension device (sprung mass pitch) or twisting of the drive system may not be able to be suppressed.

A main object of the motor control device in the present disclosure is to suppress an abnormal sound.

The motor control device according to the present disclosure employs the following means to achieve the above-described main object.

The motor control device according to the present disclosure is a motor control device used in a battery electric vehicle including a motor outputting power to a drive shaft connected to an axle via a gear mechanism, the motor control device controlling the motor such that a torque that is a sum of a required torque and an execution vibration damping torque obtained by multiplying a required vibration damping torque required for suppressing vibration by a gain is output to the drive shaft, and the motor control device being configured to set the gain, when an absolute value of the required torque is equal to or larger than a value of 0 and less than a first value larger than the value of 0, to the value of 0 or a predetermined value larger than the value of 0 and less than a value of 1, and change the gain, when the absolute value of the required torque is equal to or larger than the first value, such that the gain increases when the absolute value of the required torque is large, compared to when the absolute value of the required torque is small, toward the value of 1 from the value of 0 or the predetermined value.

In the motor control device of the present disclosure, the motor is controlled such that the torque that is a sum of the required torque required for driving and the vibration damping torque obtained by multiplying the required vibration damping torque for suppressing the vibration by a gain is output to the drive shaft. Then, when an absolute value of the required torque is equal to or larger than a value of 0 and less than a first value larger than the value of 0, the gain is set to the value of 0 or a predetermined value larger than the value of 0 and less than a value of 1. As a result, the torque output from the motor is suppressed from vibrating between the positive torque and the negative torque, and the twisting of the drive system and the sprung mass pitch can be suppressed. Further, when the absolute value of the required torque is equal to or larger than the first value, the gain is changed such that the gain increases when the absolute value of the required torque is large, compared to when the absolute value of the required torque is small, toward the value of 1 from the value of 0 or the predetermined value. As a result, the execution vibration damping torque can be brought close to the required vibration damping torque, and the twist of the drive system or the sprung mass pitch as the vibration of the sprung structure above the suspension device can be suppressed. As a result, the abnormal sound can be suppressed. Here, examples of the “first value” and the “predetermined value” include a value slightly larger than the value of 0.

In the motor control device of the present disclosure, the motor control device may be configured to change the gain, when an absolute value of the required torque is equal to or larger than the first value and less than a second value that is larger than the first value, such that the gain increases when the absolute value of the required torque is large, compared to when the absolute value is small, toward the value of 1 from the value of 0 or the predetermined value; and set the gain to the value of 1 when the absolute value of the required torque is equal to or larger than the second value. In this way, the abnormal sound can be more appropriately suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle equipped with a motor control device of an embodiment of the present disclosure;

FIG. 2 is a block diagram showing an example of a functional block in setting of a torque command by the ECU;

FIG. 3 is a descriptive view showing an example of a relationship between an absolute value of a required torque and a gain; and

FIG. 4 is a descriptive view showing an example of a time change of the required torque, the torque command, a required vibration damping torque, an execution vibration damping torque, and the gain.

### DETAILED DESCRIPTION OF EMBODIMENTS

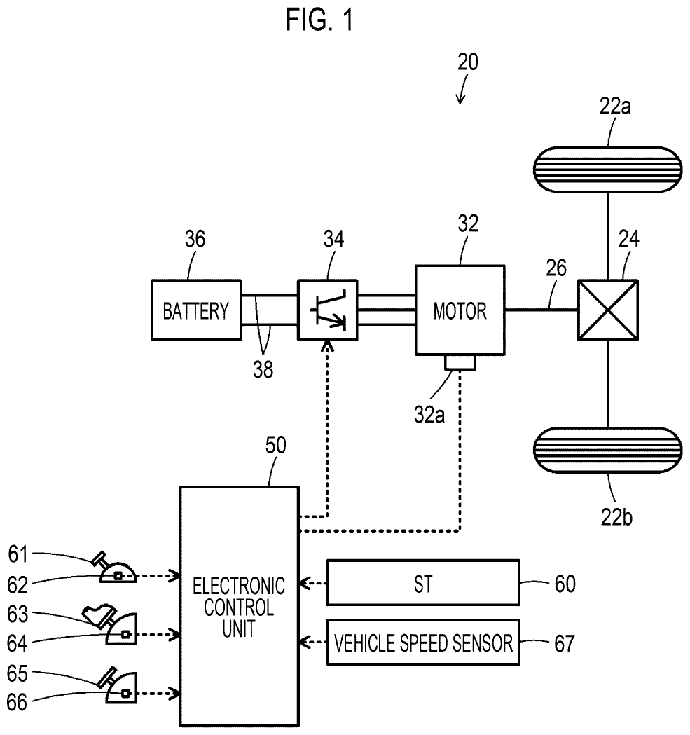

An embodiment of the present disclosure will be described with reference to the drawings. FIG. 1 is a schematic configuration diagram of a battery electric vehicle equipped with a motor control device of an embodiment of the present disclosure. As shown in the drawings, the battery electric vehicle 20 of the embodiment includes a motor 32 for traveling, an inverter 34, a battery 36 as a power storage device, and an electronic control unit (hereinafter, referred to as “ECU”) 50. The battery electric vehicle 20 further includes a suspension device that connects the drive wheels 22a, 22b and the unillustrated driven wheels to the vehicle body to suppress the transmission of an impact or vibration from the road surface to the vehicle cabin.

The motor 32 is configured as a three-phase alternating current motor, and includes a rotor in which a permanent magnet is embedded in a rotor core and a stator in which three-phase coils are wound around a stator core. The rotor of the motor 32 is connected to a drive shaft 26 connected to the drive wheels 22a, 22b via a differential gear (gear mechanism) 24.

The inverter 34 is used to drive the motor 32 and is connected to an electric power line 38. When the direct current voltage acts on the inverter 34, the switching control of a plurality of switching elements of the inverter 34 is performed by the ECU 50, so that a rotating magnetic field is formed in the three-phase coil of the motor 32, and the motor 32 is rotationally driven.

The battery 36 is configured as, for example, a lithium ion secondary battery or a nickel-metal hydride secondary battery having a rated voltage of about several hundred volts, or a fuel cell, and is connected to the electric power line 38.

The ECU 50 includes a microcomputer, and the microcomputer includes a CPU, a ROM, a RAM, a flash memory, an input/output port, and a communication port. Signals from various sensors are input to the ECU 50 via input ports. Examples of the signals input to the ECU 50 include: a rotational position θm from a rotational position sensor (for example, a resolver) 32a that detects a rotational position of a rotor of the motor 32; a phase current Iv, Iw from a current sensor that detects a V-phase current, a W-phase current of the motor 32; a voltage Vb from a voltage sensor attached between terminals of the battery 36; a current Ib from a current sensor attached to an output terminal of the battery 36; a start signal from a start switch 60; a shift position SP from a shift sensor 62 that detects an operation position of a shift lever 61; an accelerator operation amount Acc from an accelerator sensor 64 that detects a depression amount of an accelerator pedal 63; a brake pedal position from a brake sensor 66 that detects a depression amount of a brake pedal 65; a vehicle speed V from a vehicle speed sensor 67; and a battery temperature Tb from a temperature sensor that detects a temperature of the battery 36.

Various control signals are output from the ECU 50 via output ports. Examples of the signal output from the ECU 50 include a control signal to the inverter 34. The ECU 50 calculates the power storage ratio SOC of the battery 36 based on the current Ib of the battery 36 from the current sensor. The power storage ratio SOC is a ratio of a capacity of electric power that can be discharged from the battery 36 to the total capacity of the battery 36.

In the battery electric vehicle 20 of the embodiment configured as described above, the ECU 50 performs switching control of a plurality of transistors of the inverter 34 such that the motor 32 is driven by the torque command Tm*.

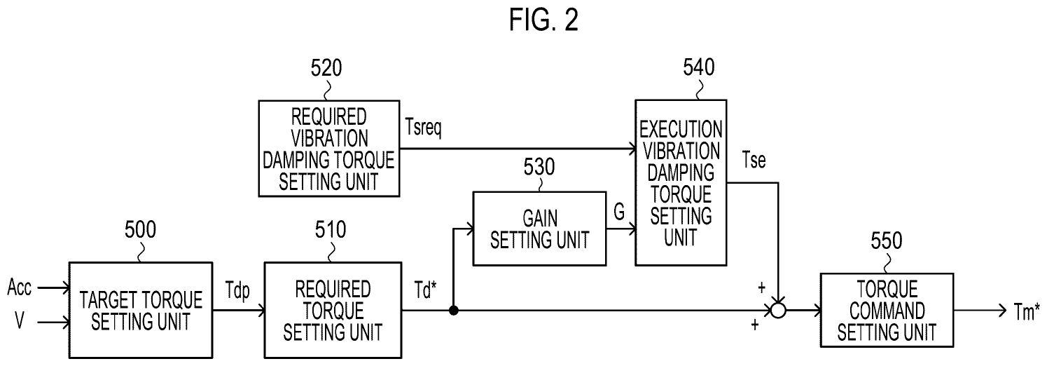

Next, the operation of the battery electric vehicle 20 of the embodiment configured as described above, particularly the operation when the torque command Tm* is set will be described. FIG. 2 is a block diagram showing an example of a functional block in setting of a torque command by the ECU. As a functional block in FIG. 2, the ECU 50 includes a target torque setting unit 500, a required torque setting unit 510, a required vibration damping torque setting unit 520, a gain setting unit 530, an execution vibration damping torque setting unit 540, and a torque command setting unit 550.

The target torque setting unit 500 sets the target torque Tdp as a target value of the torque to be output to the drive shaft 26 based on the accelerator operation amount Acc and a vehicle speed V. The target torque setting unit 500 sets the target torque Tdp to be larger when the accelerator operation amount Acc is large, compared to when the accelerator operation amount Acc is small, and to be larger when the vehicle speed V is high, compared to when the vehicle speed V is low.

The required torque setting unit 510 sets the required torque Td* such that the torque output to the drive shaft 26 changes at a first rate toward the target torque Tdp from the current torque. The “first rate” may be a rate at which a shock due to a sudden change in the torque output to the drive shaft 26 does not occur.

The required vibration damping torque setting unit 520 sets a required vibration damping torque Tsreq for suppressing the vibration of the vehicle. The required vibration damping torque setting unit 520 sets the required vibration damping torque Tsreq as the torque having the amplitude a centered on the value of 0 and having the same frequency f as the vibration generated in the vehicle and being in the opposite phase to the vibration generated in the vehicle. The frequency f can be exemplified by a frequency fpb determined in advance as a fundamental frequency of the pitching by an experiment, analysis, machine learning, or the like. The amplitude a is set to a value a1 when the vehicle travels on a flat road, and is set to a value a2 larger than the value a1 when the vehicle travels on a road surface having a relatively large unevenness. The values a1, a2 are values determined in advance by experiments, analyses, or machine learning. The required vibration damping torque setting unit 520 determines whether the vehicle travels on a flat road or whether the vehicle travels on a road surface having a relatively large unevenness by using map information stored in a navigation system (not shown) and road surface information at each point.

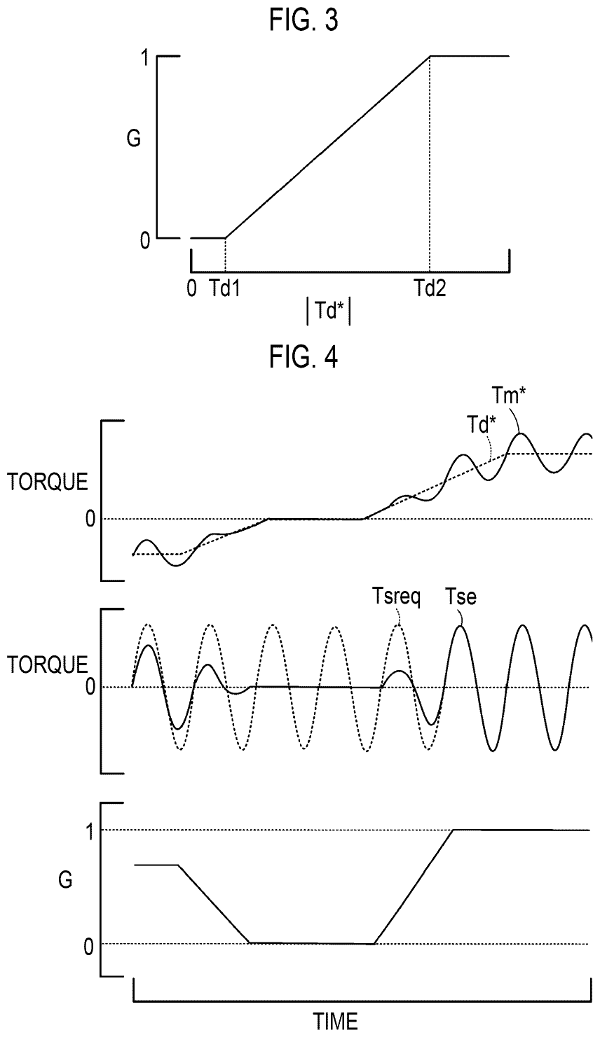

The gain setting unit 530 sets the gain G by using the required torque Td*. FIG. 3 is a descriptive view showing an example of a relationship between an absolute value of the required torque and a gain. The gain setting unit 530 sets the gain G to a value of 0 when the absolute value |Td*| of the required torque Td* is equal to or larger than the value of 0 and less than a first value Td1 larger than the value of 0. Then, the gain setting unit 530 changes the gain G at the second rate when the absolute value |Td*| is equal to or larger than the first value Td1 and less than the second value Td2 larger than the first value Td1. More specifically, the gain setting unit 530 changes the gain G at a second rate such that the gain G increases when the absolute value |Td*| is large, compared to when the absolute value |Td*| is small, toward the value of 1 from the value of 0. Further, the gain setting unit 530 sets the gain G to the value of 1 when the absolute value |Td*| of the required torque Td* is equal to or larger than the second value Td2.

The execution vibration damping torque setting unit 540 sets the execution vibration damping torque Tse by multiplying the required vibration damping torque Tsreq by the gain G. Since the gain G is the value of 0 when the absolute value |Td*| of the required torque Td* is equal to or larger than the value of 0 and less than the first value Td1, thus the execution vibration damping torque setting unit 540 sets the execution vibration damping torque Tse to the value of 0. When the absolute value |Td*| of the required torque Td* is equal to or larger than the first value Td1 and less than the second value Td2, the gain G is changed such that the gain G increases when the absolute value |Td*| is large, compared to when the absolute value |Td*| is small, toward the value of 1 from the value of 0. An amplitude of the execution vibration damping torque Tse is changed to be larger when the absolute value |Td*| is large, compared to when the absolute value |Td*| is small. When the absolute value |Td*| of the required torque Td* is equal to or larger than the second value Td2, the gain G is the value of 1, and thus the execution vibration damping torque setting unit 540 sets the execution vibration damping torque Tse to the torque having the same amplitude as the required vibration damping torque Tsreq.

The torque command setting unit 550 sets the torque command Tm* to a result (=(Td*+Tse)/Gr) of the torque that is a sum of the required torque Td* and the execution vibration damping torque Tse, by multiplying the reciprocal of the gear ratio Gr of the differential gear 24. The ECU 50 performs switching control of the transistors of the inverter 34 based on the torque command Tm* set in this way.

FIG. 4 is a descriptive view showing an example of a time change of the required torque, the torque command, a required vibration damping torque, an execution vibration damping torque, and the gain. In the figure, a solid line indicates a torque command Tm* and an execution vibration damping torque Tse and a gain G. A broken line indicates a required torque Td* and a required vibration damping torque Tsreq.

When the absolute value |Td*| of the required torque Td* is equal to or larger than the value of 0 and less than the first value Td1, that is, when the absolute value |Td*| is near a a value of 0, the torque command Tm* is set to the required torque Td*. Therefore, the torque output from the motor 32 is suppressed from vibrating between the positive torque and the negative torque across the value of 0. As a result, the vibration due to the twisting of the drive shaft 26 and the vibration (pitch) of the sprung structure above the suspension device can be suppressed, and the abnormal sound can be suppressed.

When the absolute value |Td*| of the required torque Td* is equal to or larger than the first value Td1 and less than the second value Td2, the torque command Tm* is obtained by adding the execution vibration damping torque Tse to the required torque Td*. Therefore, the execution vibration damping torque Tse approaches the required vibration damping torque Tsreq. As a result, the vibration due to the twisting of the drive shaft 26 and the vibration of the sprung structure above the suspension device can be more appropriately suppressed. As a result, the abnormal sound can be more appropriately suppressed.

With the battery electric vehicle 20 of the present embodiment described above, when the absolute value |Td*| of the required torque Td* is the value of 0 or more and less than the first value Td1, the gain G is set to the value of 0. When the absolute value |Td*| of the required torque Td* is equal to or larger than the first value Td1 and less than the second value Td2, the gain G is changed such that the gain G increases when the absolute value |Td*| is large, compared to when the absolute value |Td*| is small, toward the value of 1 from the value of 0. When the absolute value |Td*| of the required torque Td* is equal to or larger than the second value Td2, the gain G is set to the value of 1. As a result, the abnormal sound can be suppressed.

In the battery electric vehicle 20 according to the above-described embodiment, when the absolute value |Td*| of the required torque Td* is the value of 0 or more and less than the first value Td1, the gain G is set to the value of 0. However, the gain G may be a predetermined value slightly larger than the value of 0 and smaller than the value of 1.

In the battery electric vehicle 20 according to the above-described embodiment, when the absolute value |Td*| of the required torque Td* is equal to or larger than the first value Td1 and less than the second value Td2, the gain G is changed at the second rate such that the gain G increases when the absolute value |Td*| is large, compared to when the absolute value |Td*| is small, toward the value of 1 from the value of 0. When the absolute value |Td*| of the required torque Td* is equal to or larger than the second value Td2, the gain G is set to the value of 1. However, when the absolute value |Td*| of the required torque Td* is equal to or larger than the first value Td1, the gain G may be set as follows. The gain G is changed at the second rate such that the gain G increases when the absolute value |Td*| is large, compared to when the absolute value |Td*| is small, toward the value of 1 from the value of 0, and the gain G is maintained at the value of 1 after the gain G becomes the value of 1.

In the battery electric vehicle 20 of the above-described embodiment, the gain G is changed at the second rate such that the gain G increases when the absolute value |Td*| of the required torque Td* is equal to or larger than the first value Td1 and less than the second value Td2, toward the value of 1 from the value of 0. In this case, the gain G is changed to be larger when the absolute value |Td*| is large compared to when the absolute value |Td*| is small. However, the gain G may be changed such that the gain G increases when the absolute value |Td*| is large, compared to when the absolute value |Td*| is small, toward the value of 1 from the value of 0, and may be changed in a curved shape.

In the battery electric vehicle 20 of the above-described embodiment, the target torque Tdp is set based on the accelerator operation amount Acc and the vehicle speed V. The required torque Td* is set as the torque that is output to the drive shaft 26 and changes at a first rate toward the target torque Tdp from the current torque. However, the required torque Td* may be set to be larger when the accelerator operation amount Acc is large compared to when the accelerator operation amount Acc is small, and to be larger when the vehicle speed V is high, compared to when the vehicle speed V is low, based on the accelerator operation amount Acc and the vehicle speed V.

In the embodiment, the present disclosure is applied to a battery electric vehicle 20 including a motor as a power source for traveling. The present disclosure may be applied to a hybrid electric vehicle including an engine and a motor as a power source for traveling.

The correspondence between the main elements of the embodiment and the main elements of the disclosure described in the column of the means for solving the problems will be described. In the embodiment, the motor 32 corresponds to the “motor”, and the ECU 50 corresponds to the “control device”.

The correspondence between the main elements of the embodiment and the main elements of the disclosure described in the column of means for solving the problem is an example for specifically describing the embodiment for implementing the disclosure described in the column of means for solving the problem. That is, the interpretation of the disclosure described in the column of the means for solving the problem should be made based on the description in the column, and the embodiment is merely a specific example of the disclosure described in the column of the means for solving the problem.

Although the embodiment for implementing the present disclosure has been described above using the embodiments, the present disclosure is not limited to such an embodiment. The present disclosure can be implemented in various forms without departing from the gist of the present disclosure.

The present disclosure can be used in a manufacturing industry of a motor control device.

What is claimed is:

1. A motor control device used in a battery electric vehicle including a motor outputting power to a drive shaft connected to an axle via a gear mechanism, the motor control device controlling the motor such that a torque that is a sum of a required torque and an execution vibration damping torque obtained by multiplying a required vibration damping torque required for suppressing vibration by a gain is output to the drive shaft, and the motor control device being configured to
set the gain, when an absolute value of the required torque is equal to or larger than a value of 0 and less than a first value larger than the value of 0, to the value of 0 or a predetermined value larger than the value of 0 and less than a value of 1, and
change the gain, when the absolute value of the required torque is equal to or larger than the first value, such that the gain increases when the absolute value of the required torque is large, compared to when the absolute value of the required torque is small, toward the value of 1 from the value of 0 or the predetermined value.

2. The motor control device according to claim 1, wherein the motor control device is configured to
change the gain, when the absolute value of the required torque is equal to or larger than the first value and less than a second value that is larger than the first value, such that the gain increases when the absolute value of the required torque is large, compared to when the absolute value is small, toward the value of 1 from the value of 0 or the predetermined value; and
set the gain to the value of 1 when the absolute value of the required torque is equal to or larger than the second value.
